(19) United States
(12) Patent Application Publication
(10) Pub. No.: US 2012/0060658 A1
(43) Pub. Date: Mar. 15, 2012

(54) Apparatus and method for slicing food products

(75) Inventor: Günther Weber, Gross Nemerow (DE)

(73) Assignee: Weber Maschinenbau GmbH Breidenbach, Breidenbach (DE)

(21) Appl. No.: 13/182,257

(22) Filed: Jul. 13, 2011

(30) Foreign Application Priority Data
Jul. 14, 2010 (DE) 10 2010 027126.8

(51) Int. Cl. B26D 7/06; B26D 7/01

(52) U.S. Cl. 83/13; 83/409; 83/412

(57) ABSTRACT

An apparatus for slicing food products includes a product feed which supplies a product to be sliced along a product supply direction to a cutting plane in which a cutting blade moves, in particular in a rotating and/or revolving manner, with the product feed including at least one product conveyor designed for the continuous conveying of the product and product holder which can be brought into engagement with the product, in particular with a rear product end. The product holder is designed to be adjusted after the start of the slicing process from a waiting position releasing the path for the product into a working position behind the product and/or in the path for the product and back into the waiting position after the end of the slicing process.

The present invention relates to an apparatus for slicing food products, in particular to a high-performance slicer, having a product feed which supplies a product to be sliced along a product supply direction to a cutting plane in which a cutting blade moves, in particular in a rotating and/or revolving manner, wherein the product feed includes at least one production conveyor designed for the continuous conveying of the product and a product holder which can be brought into engagement with the product, in particular with a rear product end.

Such cutting apparatus serve to slice food products such as sausage, cheese, ham and the like at a high cutting frequency. The cutting quality in high-performance slicers decisively depends on how securely and reliably the product is held and guided during the slicing process. The named combination of a product conveyor (continuous conveyor) designed for the continuous conveying of the product, for example a band conveyor, belt conveyor or roller conveyor, and a separate holder for the rear product end can in this respect help to ensure the required secure product guidance. In addition, further measures can also be provided for the active conveying or advancing of the product and/or for the passive guidance or holding of the product in order thus to improve the cutting quality.

It is, however, problematic with a product holder to be brought alternately into engagement with respective product ends that it has to be moved back into its starting position again—independently of whether it contributes itself to the product advance or is only “dragged along” for stabilization with the product—after the end of the slicing process before a new product can be sliced. A restoring movement of the product holder must therefore always take place between two products to be sliced after one another. The throughput and thus the economy of the high-performance slicer is limited by such “empty movements” so that optionally—in particular with specific product types such as ham—a product holder is dispensed with. However, this inevitably leads to a defective product guidance toward the end of the slicing process and in specific cases event to an unwanted slicing of parts of the product end actually to be treated as rejects.

It is the object of the invention to ensure a secure product guidance and product holding in cutting apparatus of the named kind and simultaneously to allow a product throughput which is as high as possible.

The object is satisfied, on the one hand, by an apparatus having the features of claim 1.

In accordance with the invention, the product holder is designed to be adjusted after the start of the slicing process from a waiting position releasing the product into a working position behind the product and/or in the path for the product and back into the waiting position at the end of the slicing process and/or the product holder and the product conveyor form a unit or belong to a common assembly, with the product holder preferably being integrated in the product conveyor. By these measures, which can be present individually or in combination, the advantages of a product feed with a product conveyor and a product holder can be utilized without hereby impairing the product throughput, as is the case in the apparatus in accordance with the prior art. The product holder in particular does not have to be moved back over the total conveying path into the starting position in an apparatus in accordance with the invention.

A working position is to be understood very generally under “in the path for the product” in which the product holder is in engagement with the product and into which the product holder moves in that it is moved at least partly into the region which is adopted at least at times by the product on the supply to the cutting blade. The product holder can e.g. engage into the product from the side or from the top without being located completely behind the product in this respect.

The invention is based in part on the recognition that it is generally not necessary to leave the product holder in engagement with the product during the total slicing process since the product-guiding and/or product-holding effect of the product holder anyway only comes into force toward the end of the slicing process when namely the engagement surface of the continuous product conveyor has fallen to a minimum. The problem of empty movements can be avoided by an adjustability of the product holder between a waiting position and a working position behind the product and/or in the path for the product. The product holder is namely positioned in the waiting position before the start of the slicing process, specifically before the insertion of a new product to be sliced into the cutting apparatus, whereby the conveying path of the product feed is released. It is not necessary to move the product holder into a starting position behind the newly provided product. The waiting position can rather be located at any desired position of the conveying path, in particular relatively closely to the cutting blade. The product holder can be moved from the waiting position, after the product has been moved past it or is located in its region, into the working position and can be brought into engagement with the product, in particular with the rear end region of the product or with the rear product end. Subsequently, e.g. either the unit of product conveyor and product holder can be moved as a whole in the direction of the cutting plane or the product holder can be moved in the direction of the cutting plane relative to the product conveyor. Dead times in the slicing of a plurality of products after one another are avoided and thus the efficiency of the cutting apparatus is improved both by adjusting the product holder after the start of the slicing process from a waiting position releasing the path for the product into a working position behind the product or in the path for the product and after the end of the slicing process back into the waiting position and by a design of the product holder and of the product conveyor as a unit or by an association of the product holder and the product conveyor to form a common assembly.

Further developments of the invention are set forth in the dependent claims, in the description and in the enclosed drawings.

The adjustment movement of the product holder preferably takes place with a component transverse to the product supply direction. The product holder is therefore moved into the working position behind the product or in the path for the product from above, from below or from the side. Alternatively, the product holder could also be moved into the working position and back into the waiting position by means of a rotary movement or a pivoting movement. It is naturally also conceivable that the product holder carries out a combination of different movements to change between the waiting position and the working position.

In accordance with an embodiment, the product holder is effective in the end region of a product conveying path extending along the product supply direction, said end region being disposed at the cutting plane. The product conveying path in this respect designates the region between the cutting plane and the rear product end of a product to be newly provided at the product feed. Dead times which otherwise result by a moving back of the product holder over the total conveying path are avoided by provision of the product holder in the proximity of the cutting plane.

The product holder is preferably spaced apart from the cutting plane in the waiting position. The product holder can thus move along with the product over a specific path, which e.g. essentially corresponds to the spacing apart, after a transition from the waiting position into the working position and can thus serve for the product guidance and the product holding.

The product holder is preferably arranged next to the product or above the product in the waiting position. The product holder can be moved from this position in a simple manner behind the product and/or into the path for the product, provided that the rear product end has already moved past the product holder or is located in the region of the product holder.

The product conveyor can include a conveyor, in particular a band conveyor, engaging at the upper product side. The product, which is, for example, located on a product support, can thus be in contact with the conveyor over a relatively large area. As mentioned above, a belt conveyor, a multitrack conveyor or a roller conveyor can also be provided instead of a band conveyor. A plurality of conveyors engaging at the upper product side could generally also be provided.

In accordance with a further embodiment, the band conveyor is at least partly lowerable behind the product to move the product holder from the waiting position into the working position. A product holder integrated into the band conveyor can be moved from the waiting position into the working position by the lowering of the band conveyor. A separate adjustment of the product holder relative to the band conveyor is not necessary in this embodiment.

Provision is made in accordance with a further embodiment of the invention that the product conveyor includes at least one endless belt with which the product holder can be coupled such that the product holder is taken along by the endless belt in the working position and is out of engagement with the endless belt in the waiting position.

A substantial simplification of the product feed can be achieved in this manner. The function of the product holder is so-to-say taken over from the endless belt in this process. In other words, a part of the endless belt is in this respect used as a product holder. The specific embodiment is generally as desired for this purpose.

In a preferred embodiment, one or more pin elements or needle elements are provided arranged distributed transversely to the product supply direction, said pin or needle elements not being moved with the endless belt in a waiting position and releasing the path for the product, with these pin-like or needle-like holding elements being able to be brought into engagement with the product, on the one hand, and being able to be coupled with the endless belt, on the other hand, to move together with the endless belt in the direction of the cutting plane and to hold or guide the product in so doing. Provision can be made in this respect that the holding elements, which act, for example, in the manner of a fork having a plurality of prongs, pierce the product from above or from the side.

It is also possible to provide a plurality of arrangements (each with one or more holding elements arranged distributed transversely to the product supply direction) behind one another in the product supply direction and to design these arrangements adjustable individually from one another. These arrangements can then be brought into and out of engagement with the product after one another in time. In particular a product handling matched individually to the respective application and in particular to the respective product can take place by means of such a product holder formed by needles or pins which can be coupled directly to the endless belt.

An advantage of such a pin holder or needle holder is that the size of the end pieces, which are no longer sliceable, can be further minimized. Cutting can take place so-to-day “down to the last slice”.

The mutual intervals of the individual pin-shaped or needle-shaped holding elements can be made adjustable, and indeed transversely to the product supply direction and/or in the product supply direction.

It is furthermore possible to configure the penetration depth of the individual elements into the product differently. It can in particular be advantageous if only the element cooperating furthest back with the product penetrates comparatively deep into the product so that so-to-say only the “last slice” is completely gripped or held by means of the product holder.

In accordance with a further embodiment, the product holder is arranged in a front end region of the product conveyor facing the cutting plane and the front end region of the product conveyor is adjustable in the product supply direction between a starting position spaced apart from the cutting plane and an end position disposed closer to the cutting plane. The end position can in particular be located directly at the cutting blade, that is the end position can be selected such that the product is held and guided toward the end of the slicing process as long as possible by means of the product holder. The start position is preferably located at a predefined spacing from the cutting plane, but relatively close to the cutting blade with respect to the total conveying path since then the restoring movement only has to take place over a relatively short path and can be carried out correspondingly fast.

In accordance with an embodiment, the product conveyor is adjustable as a whole relative to the cutting blade. The product holder can then be fixedly attached to the product conveyor since an individual movement of the product holder in the product supply direction is not absolutely necessary.

A downholder to hold and/or guide the product can be provided between a front end of the product conveyor and the cutting plane. The free space between the front end of the product conveyor and the cutting plane is bridged by means of such a downholder which can in particular include round bars and/or sheet metal parts in order also to prevent unwanted product movements during the slicing process in this region.

In accordance with a further embodiment, the product conveyor reaches up to the cutting plane, with the product holder being adjustable relative to the product conveyor in the product supply direction, in particular between a start position spaced apart from the cutting plane and an end position disposed closer to the cutting plane. In this embodiment, bridging downholders can be dispensed with since the product conveyor provides a secure guidance of the product up to the cutting plane. If the application should require, additional downholders can nevertheless be provided. The product holder can also be directly integrated in the product conveyor in this embodiment. For example, the product holder could be supported on a linear guide of the product conveyor and can be provided with a controlled drive.

The product holder can include, in accordance with an embodiment of the invention, a controllable gripping apparatus, in particular at least two mutually pivotable holding claws. A safe control of the product during the slicing can generally be achieved by griping the rear product ends by means of the holding claws, in particular by piercing the product with the holding claws.

In accordance with a further embodiment of the invention, the product conveyor is designed to apply an increased holding or clamping force onto the product during the adjustment of the product holder into the working position.

The product conveyor can, for example, be an endless belt which engages at the upper product side and which applies a specific pressure or a specific holding or clamping force to the product, in particular from above, during the product supply with a product holder still in the waiting position. The embodiment in question here proposes to increase this pressure or this holding or clamping force so that the product is securely held or clamped by means of the product conveyor on the adjustment of the product holder into the working position, that is when the product holder is brought into engagement with the product. It is hereby avoided that the product is subject to a maladjustment on the engaging of the product holder. The product supply is preferably neither interrupted nor slowed down during this process, i.e. the process of the slicing of the respective product is not impaired by the moving of the product holder into the working position. The application of the increased holding or clamping force onto the product by the product conveyor can start a preset time interval before the moving of the product holder into the working position. The length of this time interval can be selected in dependence on the respective circumstances, for example on the properties of the respective product.

The above-named object is furthermore satisfied by a method of slicing food products, in particular by means of a high-performance slicer, wherein at least one product to be sliced, in particular a plurality of products after one another, is supplied along a product supply direction to a cutting plane in which a cutting blade moves, in particular in a rotating and/or revolving manner, wherein a product holder which can be brought into engagement with the product is positioned in a waiting position releasing the path for the product, the product is supplied by means of a continuous product conveyor, the product holder is moved in a working position behind the product and/or in the path of the product when the rear product end has moved past the product holder located in the waiting position or is located in the region of the product holder, the product holder is brought into engagement with the product, in particular with the rear end region of the product or with the rear product end, and the product holder and the product are moved along the product supply direction and the product holder is returned into the waiting position when the slicing process is concluded. The product holder is therefore not used during the total slicing process, but it only grips the product during the slicing process, preferably toward the end of the slicing process, in order to supply said product to the cutting plane in the further procedure or to move with it to control the product.

The product holder in particular grips the product while the product is moving toward the cutting plane.

The product holder can assist the product conveyor in the supply of the product or can take over the supply of the product from the product conveyor when the product holder is in engagement with the product.

The product holder and the product conveyor can in particular form a unit or belong to a common assembly, with the product holder preferably being integrated into the product conveyor, and with the product holder being moved relative to the product conveyor to supply the product or with the product conveyor being moved as a whole together with the product holder.

The time for the moving of the product holder into the working position can be recognized by means of the product feed and/or by a suitable sensor system, e.g. by a light barrier recognizing the rear product end.

The invention will be described in the following by way of example with reference to the drawing.

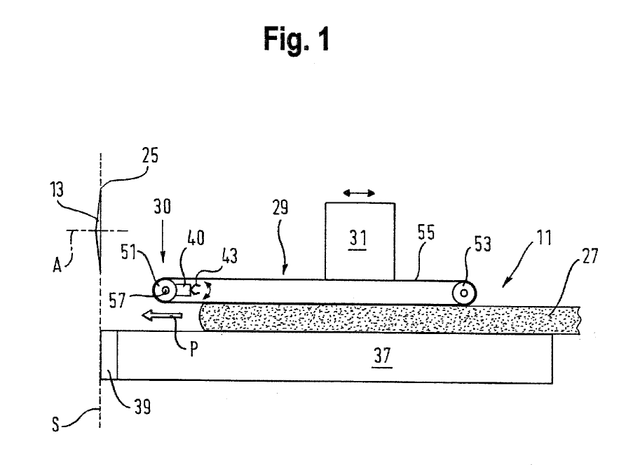

FIG. 1 shows a simplified side view of a cutting apparatus in accordance with a first embodiment of the invention;

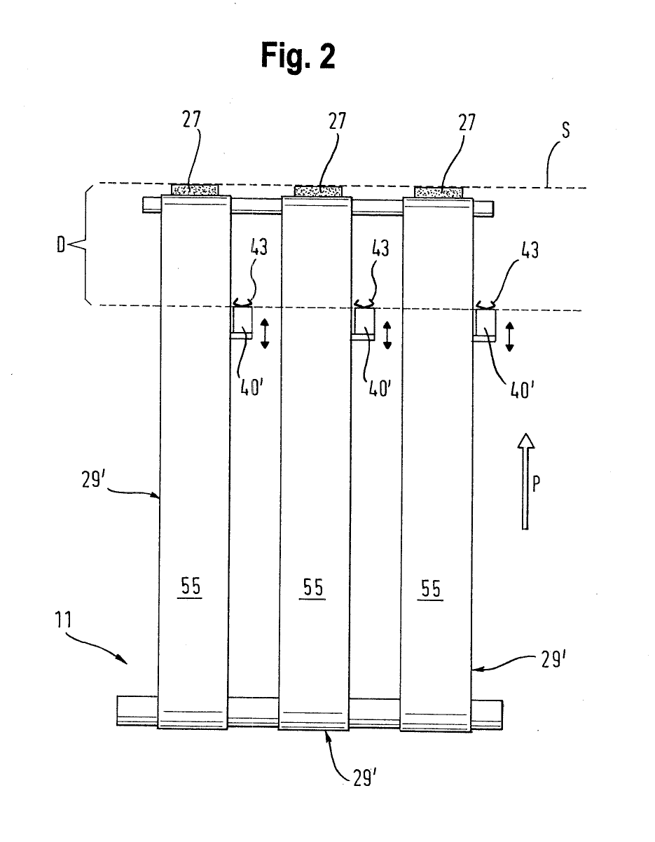

FIG. 2 shows a plan view of a cutting apparatus in accordance with a second embodiment of the invention;

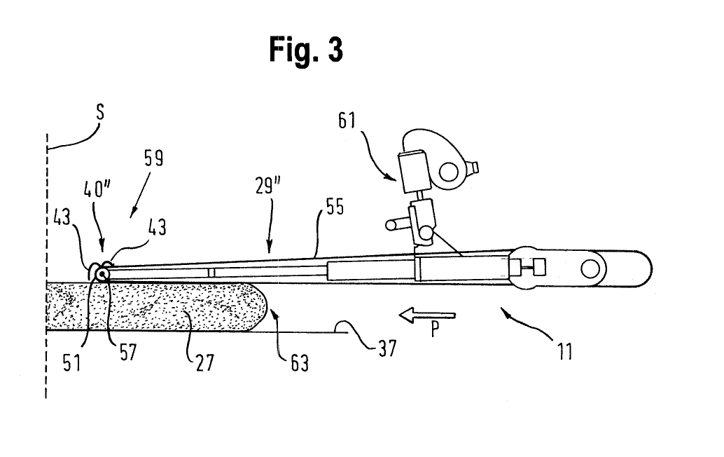

FIG. 3 shows a side view of a cutting apparatus in accordance with a third embodiment of the invention;

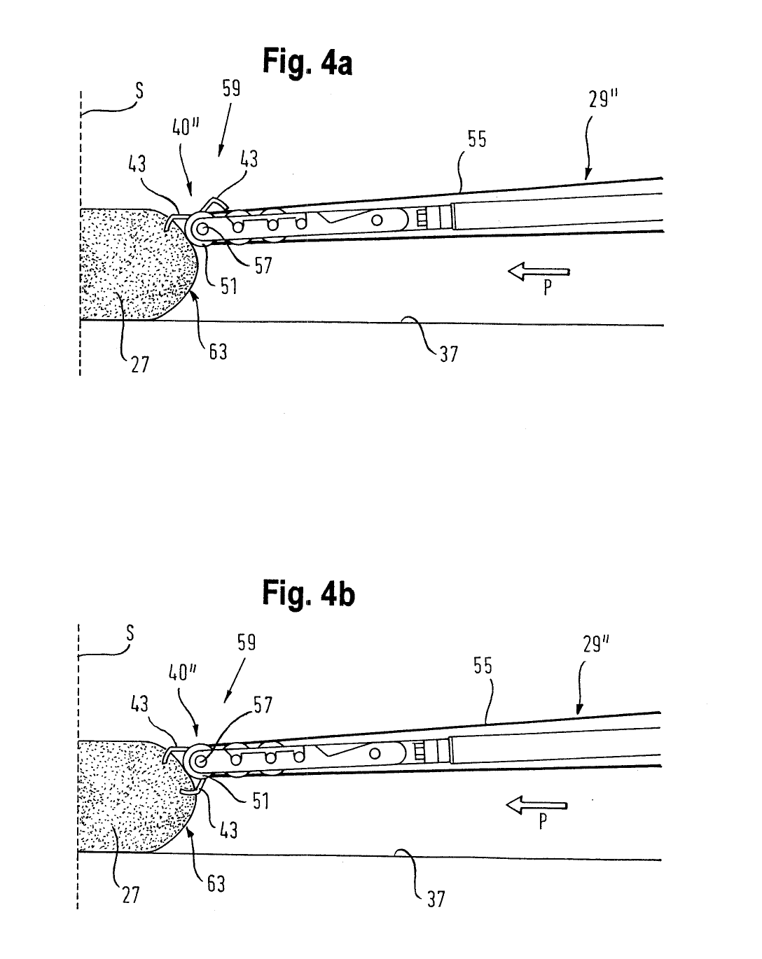

FIGS. 4a to 4d show part representations of the apparatus in accordance with FIG. 3 which correspond to a sequence of phases of a slicing process; and

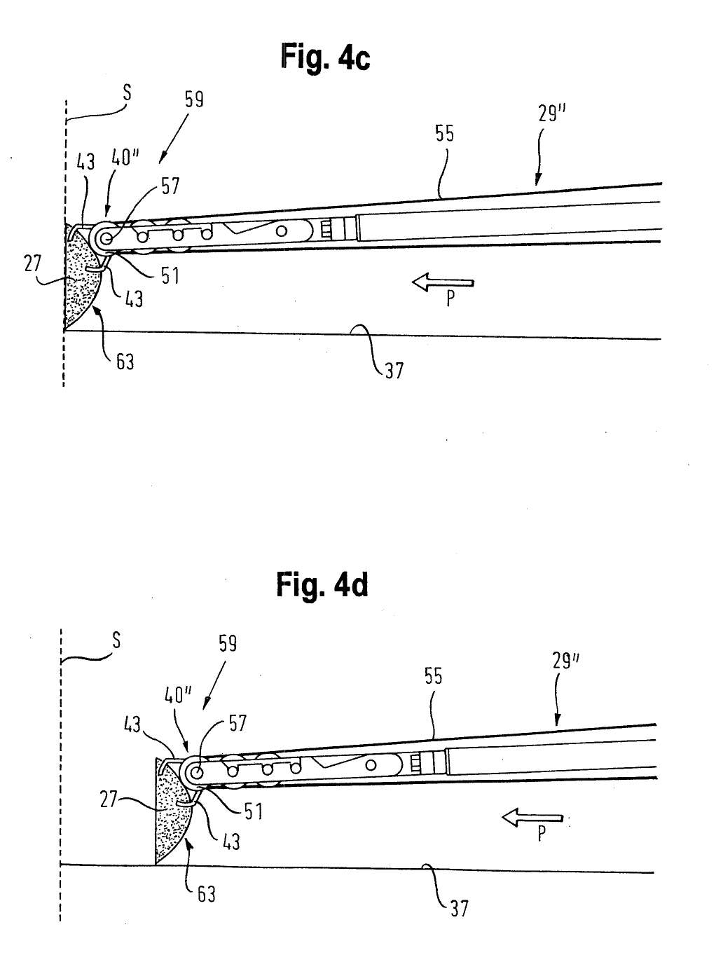

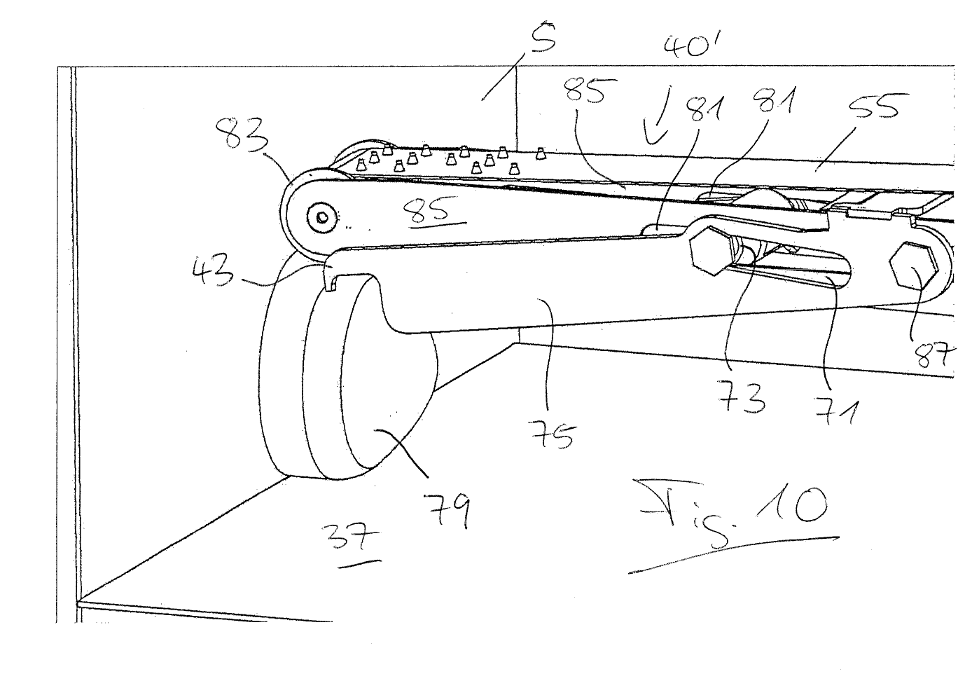

FIGS. 5 to 11 show a further embodiment of the invention in different phases during the product supply.

In accordance with FIG. 1, a high-performance slicer includes a product feed 11 and a cutting blade 13. The cutting blade 13 is made as a circular blade here which rotated about a blade axis A and additionally revolves in a planetary motion about a center axis, not shown. Alternatively, the cutting blade could also be made as a scythe-like blade which only rotates about the blade axis A. Independently of the design of the cutting blade 13, its cutting edge 25 defines a cutting plane S which here extends at a right angle to the blade axis A. The product feed 11 includes a planar product support 37 on which a product bar 27 lies. A band conveyor 29 engaging at the upper side of the product bar 27 and having a front deflection roller 51, a rear deflection roller 53 and a revolving conveyor band 55 provides that the product bar 27 is continuously supplied along a product feed P to the cutting plane S during the cutting operation. Further band conveyors which engage laterally at the product bar, 27, for example, can be provided in dependence on the application. In addition, the product support 37 itself could generally be formed as a band conveyor. A front end element 39 of the product support 37 reaches up to the cutting plane S and defines a horizontal cutting edge which cooperates as a counter-edge with the cutting blade 13 during the cutting operation.

The band conveyor 29 is attached to a carrier frame 31 which is only shown schematically and in which the drive for the band conveyor 29 is also accommodated. The carrier frame 31 is adjustable relative to the cutting plane S in and against the product supply direction P by means of an adjustment apparatus, not shown, as is illustrated in FIG. 1 by a double arrow. Generally, instead of a single product bar 27, a plurality of product bars arranged next to one another can also be supplied together to the cutting plane S, as is the case in the embodiment in accordance with FIG. 2 to be described later.

In the front end region 30 of the band conveyor 29, a product holder 40 is provided which can be brought into engagement with a rear end of the product bar 27 not shown in FIG. 1 to hold the product bar 27 and to convey it in the product supply direction P. As can be seen from FIG. 1, the product holder 40 is integrated into the front deflection roller 51 of the band conveyor 29. The product holder 40 in the embodiment shown includes a plurality of mutually pivotable holding claws 43 which are able to grip into the rear product end. As is shown by the curved double arrow, the product holder 40 is adjustable between a waiting position shown in FIG. 1 and a working position, namely pivotable about an axis of rotation of the front deflection roller 51.

In the waiting position, the product holder 40 is located above the product bar 27 and releases the path for a movement of the product bar 27. When the product holder 40 is, in contrast, pivoted downwardly into the working position and the product bar has moved past the front deflection roller 51, the holding claws 43 reach the rear product end and can grip therein.

During the operation of the apparatus, the product bar 27 is first supplied to the cutting plane S only by means of the band conveyor 29, with a sufficient guidance and holding of the product bar 27 being ensured via the large-area contact between the conveying band 55 and the upper side of the product bar 27. Product slices can therefore be cut off from the product bar 27 at a high cutting quality by the cutting blade 13.

As soon as the read product end has moved past the product holder 40, it is detected by a suitable sensor, not shown, and reported to a control device, likewise not shown, which thereupon causes the product holder 40 to be pivoted from the waiting position into the working position. The holding claws 43 grip into the rear product end and hold it tight.

To avoid a standstill of the product bar 27, the band conveyor 43 is set into motion in the product supply direction P as a whole directly after the engaging of the holding claws 43 into the rear product end so that the product bar 27 continues to be supplied to the cutting plane S at the desired conveying speed. Briefly before the product holder 40 has reached the cutting plane S, the band conveyor 29 is stopped and the remaining product end defined as a reject is retracted from the cutting plane S and disposed of e.g. via a cut-out, not shown, in the product support 37. Finally, the product holder 40 is again pivoted into the waiting position in accordance with FIG. 1. A new product bar 27 can now be provided on the product support 37 and can again be supplied to the cutting plane S by the band conveyor 29.

The retraction of the band conveyor 29 or of the product holder 40 can take place relatively fast since the band conveyor 29 only has to be displaced by a small spacing and the product holder 40 does not have to be displaced at all, but only pivoted.

A further embodiment of the invention will be described with reference to FIG. 2, with the same or equivalent components being designated by the same reference numerals as in the embodiment in accordance with FIG. 1.

In accordance with FIG. 2, a plurality of product bars 27 are supplied to a common cutting plane S in parallel next to one another so that a plurality of product bars can be cut simultaneously using a correspondingly large cutting blade not shown in FIG. 2. Three product bars are shown next to one another only by way of example in FIG. 2. Unlike in the embodiment in accordance with FIG. 1, the band conveyors 29′ reach in the embodiment shown in FIG. 2 almost up to the cutting plane S. The product holders 40′ are arranged at a spacing D from the cutting plane S laterally next to the band conveyors 29′ and the product bars 27.

The product holders 40′ can be pivoted out of the waiting position shown in FIG. 2 laterally next to the product bars 27 into a working position behind the product bars 27 in order thus to engage in their rear product ends. Furthermore, the product holders 40′ are displaceably supported relative to the band conveyors 29′ on suitable guides, not shown, so that they can be adjusted in and against the product supply direction P, which is shown by double arrows in FIG. 2.

As in the embodiment in accordance with FIG. 1, an exclusive conveying of the product bar 27 takes place by means of the band conveyors 29′ during the cutting operation, with the product holders 40′ being located in the waiting position releasing the path for the product bars 27. As soon as the respective rear product end has moved past the product holder 40′, it is moved into the working position behind the product bar 27 and the holding claws 43 grip into the rear product end. Subsequently, the product holder 40′ is moved along with the product bar 27, with it being left to the respective application, whether the advance is still effected via the band conveyor 29′, via the product holder 40′ or via both apparatus together in the further procedure.

Due to the simultaneous product guidance and product control by means of the band conveyor 29′, on the one hand, and by means of the product holder 40′, on the other hand, a particularly high cutting quality can be achieved. It is avoided at the same time that the product end determined for rejection is accidently sliced since it is securely held by the product holder 40′.

In FIG. 3, a further embodiment of the invention is shown which works in a similar manner to the embodiment in accordance with FIG. 1. The product holder 40″ is not adjustable relative to the band conveyor 29″ in this embodiment, but the holding claws 43 are rather directly integrated in the shaft 57 of the front deflection roller 51, are namely supported thereon. The holding claws 43 can for this purpose be arranged e.g. in an intermediate space between two part conveyor bands of the band conveyor 29″. To be able to move the holding claws 43 into a working position behind the product bar 27, the front end 59 of the product conveyor 29″ can be lowered. To be able selectively to lower and raise the band conveyor 29″ again, a corresponding actuator 61 is provided.

The operation of the slicer will now be described with reference to FIGS. 4a to 4d after the rear product end 63 has moved past the product holder 40″.

In accordance with FIG. 4a, one of the two holding claws 43 or holding claw arrangements is first pivoted about the shaft 57 so that it engages into the rear product end 63. Subsequently, in accordance with FIG. 4b, the further holding claw 43 is pivoted about the shaft 57 so that it also engages into the rear product end 63. Subsequently, the band conveyor 29″ is moved as a whole toward the cutting plane S in order thus to continue to supply the product bar 27 to the cutting plane S. As soon as the band conveyor 29″ has reached an end position shown in FIG. 4c in which the holding claws 43 are located just before the cutting plane S and the product bar 27 has been completely sliced except for an end piece determined as a reject, the movement of the band conveyor 29″ in the product supply direction P is stopped and the band conveyor 29″ is retracted together with the residual piece in accordance with FIG. 4d. The residual piece is disposed of as a reject. Subsequently, the product conveyor 29″ is raised again and the holding claws 43 are pivoted back into their starting position. A new product bar 27 can then be placed onto the product support 37.

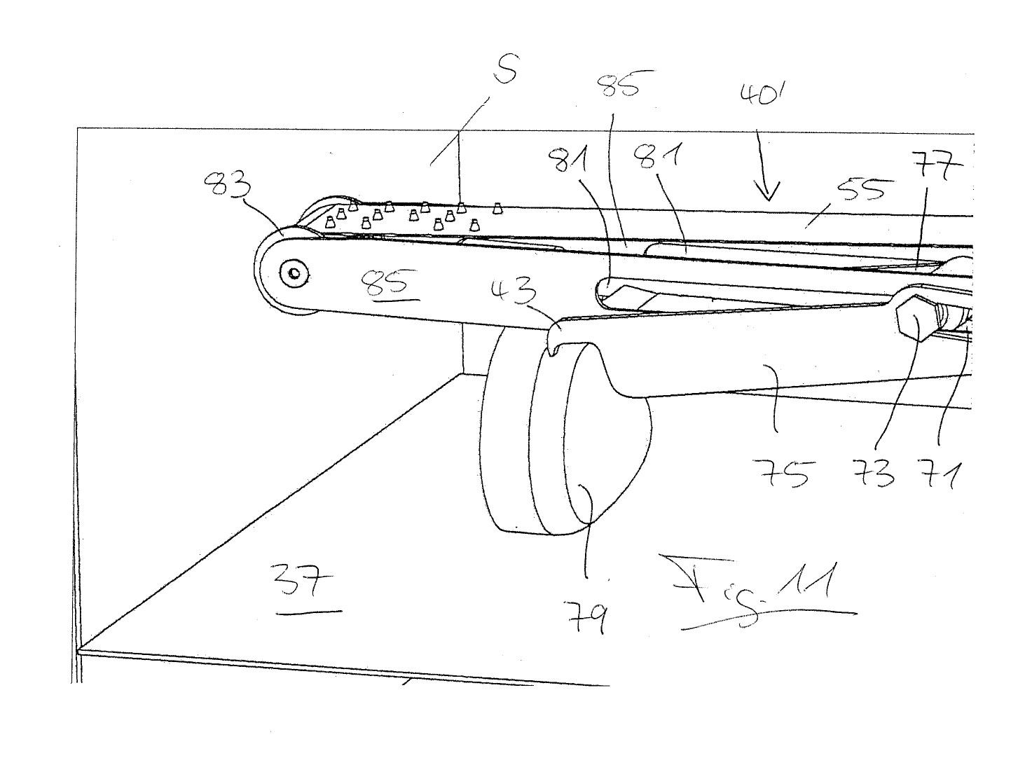

The embodiment of FIGS. 5 to 11 to this extent corresponds to the embodiment of FIG. 23 in that the band conveyor or conveyors 29′ reaches/reach up to the cutting plane S. Only one product bar 29′ is shown in FIGS. 5 to 11. A multitrack operation is also possible with respect to this embodiment in which a plurality of product bars are sliced simultaneously. A product feed 11 is then provided for each track, that is for each product bar 11, such as is shown in FIGS. 5 to 11.

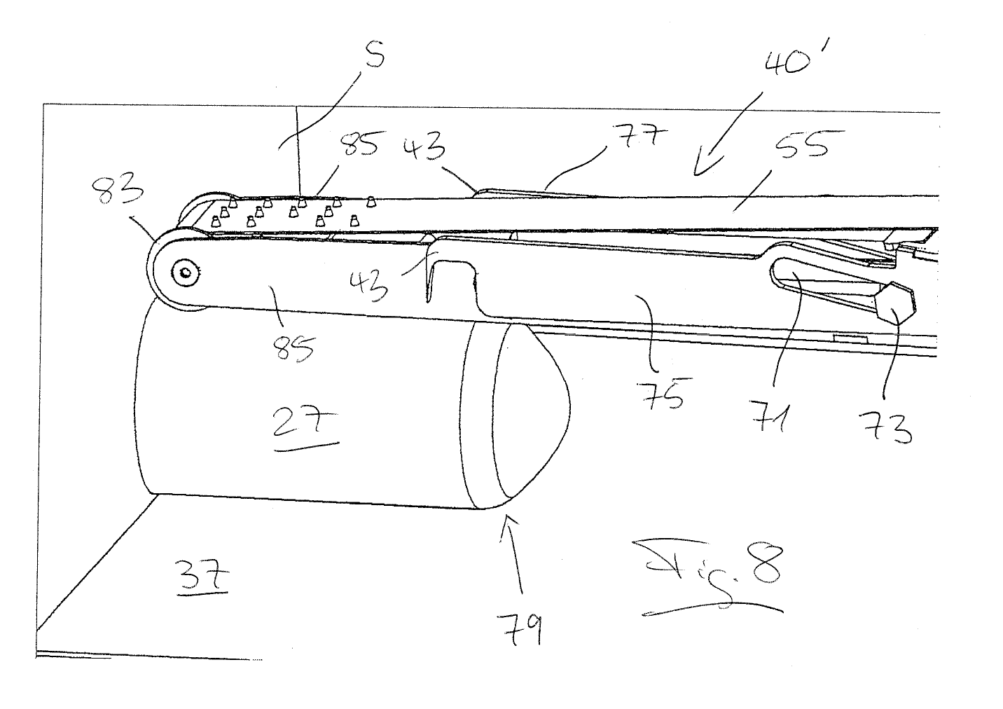

The product feed 11 includes a product conveyor 29′ which has an endless belt 55 and whose front end reaches up to the cutting plane S and acts from above on a product bar 27 to be sliced which lies on a product support 37. Side parts 85 of the band conveyor 29′ carry a deflection roller 83 for the endless belt 55 at their front ends and are provided with elongate holes 81 extending in the longitudinal extent of the band conveyor 29′ (cf. FIGS. 9-11).

The product support 37 can include a conveyor band for the product 27 so that the product 27 is moved by a common effect of this lower product conveyor and of the upper product conveyor 29′ in the direction of the cutting blade (not shown) revolving in the cutting plane S.

A product holder 40′ is integrated into the upper product conveyor 29′ and is shown in FIG. 5 in its waiting position in which it releases the path for the product 27.

The product conveyor 40′ is formed in the manner of a fork disposed at both sides of the conveyor band 55 and having two side parts 72, 77 and is supported at its end at the rear in the product supply direction P about an axis 87 relative to the side parts 85 of the band conveyor 29′. The product holder 40′ is provided with holding claws 43 at its front end.

An actuator, not shown, is designed to actuate a control arrangement by which a control element 73 cooperates with elongate holes 71 of the product holder 40′ formed in the side parts 75, 77 and acting in the manner of a control cam. The control element 73 is moreover compulsorily guided in the elongate holders 81 (cf. FIGS. 9-11) of the side parts 85 of the band conveyor 29′ and can consequently be adjusted by means of the actuator in the direction of the longitudinal extent of the product conveyor 29′ to pivot the product holder 40′ between the waiting position and the working position. In addition, the product holder 40′ can be moved toward the cutting plane S and away from the cutting plane S relative to the product conveyor 29′. This can take place independently of the conveying movement of the endless belt 55, with it being alternatively or additionally possible selectively to couple the product holder 40′ with the endless belt 55 or to release it from the endless belt 55 by suitable means.

It is possible in this manner selectively either to leave the product holder 40′ in a waiting position at a constant spacing from the cutting plane S or to move it in the direction of the cutting plane S at the conveying speed of the conveyor band 55 with a conveyor band 55 being in conveying operation.

In addition, it is possible—as mentioned—due to the cooperation of the control element 73 with the elongate hole arrangements 71, 81 to pivot the product holder 40′ by means of the actuator out of the waiting position shown in FIG. 5 into the working position to bring the holding claws 43 of the product holder 40′ into engagement with the respective product bar 27 to be sliced. This will be explained in more detail in the following. A pure pivot movement for the product holder 40′ is, however, not compulsory.

In FIG. 5, the product bar 27 is already sliced and moved in the direction of the cutting plane S in the product supply direction P by means of the band conveyor 29′. The product holder 40′ is located in the waiting position in which the product 27 can be conveyed without impairment by the product holder 40′. A rear end region 79 of the product 27 is still relatively far away from the cutting plane S.

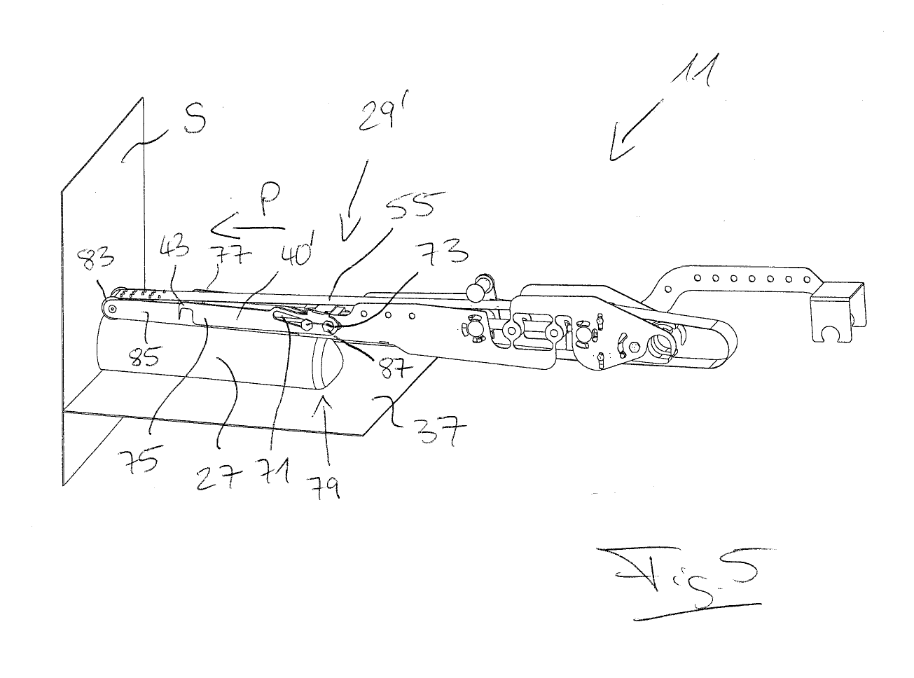

The product 27 continues to be sliced in the state in accordance with FIG. 6. The rear end region 79 of the product 27 is still relatively far away from the cutting plane S. The product holder 40′ is still located in its waiting position.

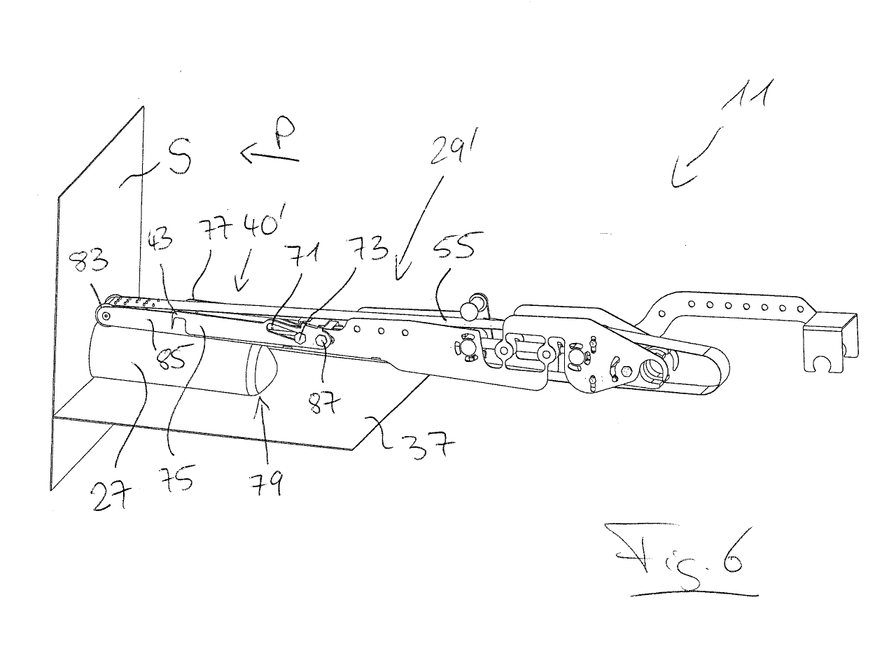

This is also the case in the state in accordance with FIG. 7. However, the rear end region 79 of the product 27 here approaches that position at which the product holder 40′ should be effective.

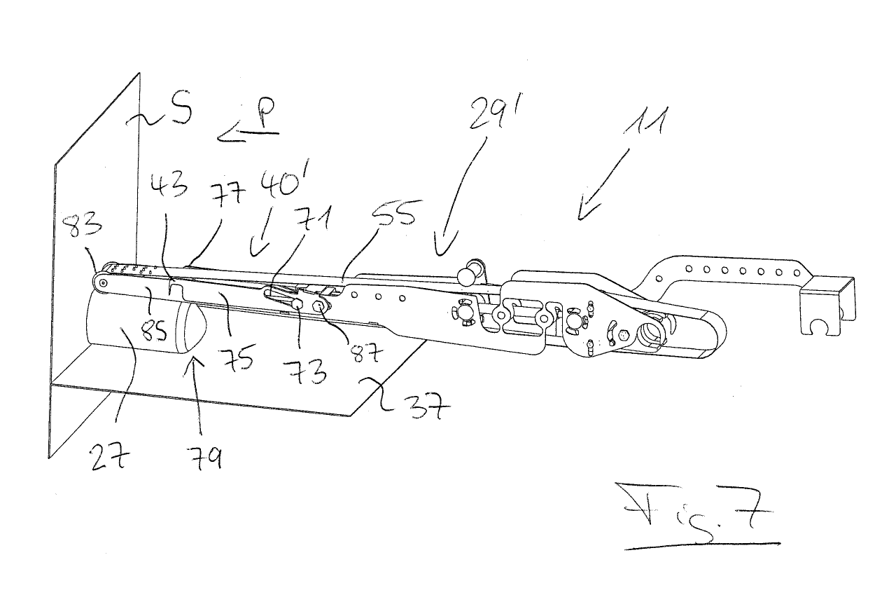

This position is reached in FIG. 8. It is recognized by means of a sensor system, not shown, for example a light barrier, that the rear end region 79 of the product 27 is located in the position in which the product holder 40′ should be effective.

The mentioned sensor system signals to a control device, not shown, that the mentioned actuator should be activated to pivot the product holder 40′ about the mentioned axis. For this purpose, the control element 73 cooperating with the elongate holes 71 and the elongate holes 81 is moved a small amount toward the cutting plane S relative to the product holder 40′, whereby the product holder 40′ is pivoted and its holder claws 43 move into engagement with the rear end region 79 of the product 27, as is shown in FIG. 9.

At the same time, the product holder 40′ is moved toward the cutting plane S at the conveying speed preset by the product feed 11 so that the rear end region 79 of the product 27 is not conveyed either more slowly or faster than the product 27 itself, i.e. the product holder 40′ does not impair the product supply despite the engagement with the product 27, but rather either behaves neutrally in this respect or assists the product supply.

Alternatively, provision can be made that a piston-in-cylinder arrangement is provided which can be activated to move out a piston holding a carrier for the product holder 40′ at its front end, and indeed at the conveying speed preset by the product feed 11 so that here the rear end region 79 of the product 79 of the product 27 is also conveyed neither more slowly nor faster than the product 27 itself, i.e. the product holder 40′ does not impair the product supply despite the engagement with the product 27, but rather either behaves neutrally in this respect or assists the product supply. In this embodiment, the product holder 40′ can be pivotably supported at the carrier, with a pure pivot movement also not being compulsory here.

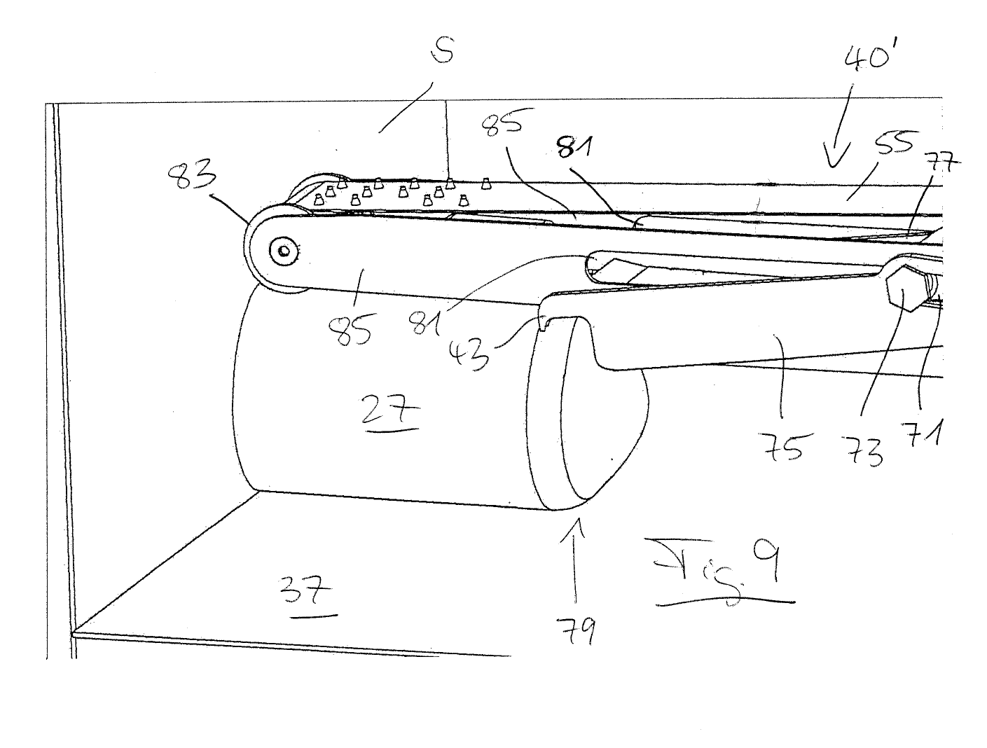

In the state in accordance with FIG. 10, the product 27 is completely sliced with the exception of the rear end region 79. The product feed 11 now reverses the conveying direction so that the rear end region 79 representing the product residue is moved away from the cutting plane S by the joint effect of the conveyor band 29′ and the product holder 40′.

The product residue 79 can then be disposed of in that, for example, the product holder 40′ is again brought out of engagement with the product residue 79 and the product residue 79 is cast off to the bottom through an otherwise closed ejection opening (not shown) which is formed in the product support. The product holder 40′ is then again located in the waiting position in accordance with FIG. 5.

As mentioned in the introduction part, provision can additionally be made that, for example just before the coming into effect of the product holder 40′, that is e.g. in the state in accordance with FIG. 8, the band conveyor 29′ is moved in the direction of the product support 37 in order hereby to apply an increased holding or clamping force to the product 27 and thus to secure the product 27 against a maladjustment when subsequently the product holder 40 is brought into engagement with the rear end region 79 of the product 27.

The invention allows the combined use of a continuous conveyor and a product holder which moves to and fro in a high-performance slicer without this being associated with significant impairments with respect to its efficiency and its economy. Since the waiting position of the product holder is relatively close to the cutting blade, the restoration movement has to be carried out so fast that no dead times result on the slicing of products after one another.

### REFERENCE NUMERAL LIST

11 product feed
13 cutting blade
25 cutting edge
27 product bar
29, 29′, 29″ band conveyor
30 front end region
31 carrier frame
37 product support
39 end element
40, 40′, 40″ product holder
43 holding claw
51 front deflection roller
53 rear deflection roller
55 conveyor band
57 shaft
59 front end
61 actuator
63 rear product end
71 elongate hole
73 control element
75 side part
77 side part
79 rear end region, product residue
81 elongate hole in the side part 85 of the band conveyor 29′
83 deflection roller
85 side part of the band conveyor 29′
87 axis
A blade axis
S cutting plane
P product supply direction
D spacing

1-15. (canceled)

16. An apparatus for slicing food products having a product feed which supplies a product to be sliced along a product supply direction to a cutting plane in which a cutting blade moves
wherein the product feed includes at least one product conveyor formed for the continuous conveying of the product and a product holder which can be brought into engagement with the product,
wherein the product holder is designed to be adjusted after the start of the slicing process from a waiting position releasing the path for the product into a working position behind the product and/or in the path for the product and after the end of the slicing process back into the waiting position; and/or
wherein the product holder and the product conveyor form a unit or belong to a common assembly.

17. An apparatus in accordance with claim 16, wherein the cutting blade moves in a rotating and/or revolving manner.

18. An apparatus in accordance with claim 16, wherein the product holder can be brought into engagement with a rear product end.

19. An apparatus in accordance with claim 16, wherein the product holder is integrated into the product conveyor.

20. An apparatus in accordance with claim 16, wherein the adjustment movement of the product holder takes place with a component transverse to the product supply direction.

21. An apparatus in accordance with claim 16, wherein the product holder is operative in the end region of a product conveying path extending along the product supply direction, said end region being disposed at the cutting plane.

22. An apparatus in accordance with claim 16, wherein the product holder is spaced apart from the cutting plane in the waiting position; and/or wherein the product holder is arranged next to the product or above the product in the waiting position.

23. An apparatus in accordance with claim 16, wherein the product conveyor is designed to apply an increased holding force or clamping force to the product at least using the adjustment of the product holder into the working position.

24. An apparatus in accordance with claim 16, wherein the product conveyor includes a conveyor engaging at the upper product side, with in particular the band conveyor being at least partly lowerable behind the product to move the product holder from the waiting position into the working position.

25. An apparatus in accordance with claim 24, wherein the conveyer is a band conveyor.

26. An apparatus in accordance with claim 16, wherein the product conveyor includes an endless belt with which the product holder can be coupled such that the product holder is taken along by the endless belt in the working position and is out of engagement with the endless belt in the waiting position.

27. An apparatus in accordance with claim 16, wherein the product holder is arranged in a front end region of the product conveyor facing the cutting plane and the front end region of the product conveyor is adjustable in the product supply directing between a starting position spaced apart from the cutting plane and an end position disposed closer to the cutting plane.

28. An apparatus in accordance with claim 16, the product conveyor is adjustable as a whole relative to the cutting blade.

29. An apparatus in accordance with claim 16, wherein a downholder for holding and/or guiding the product is provided between a front end of the product conveyor and the cutting plane.

30. An apparatus in accordance with claim 16, wherein the product conveyor reaches up to the cutting plane, with the product holder being adjustable relative to the product conveyor in the product supply direction.

31. An apparatus in accordance with claim 30, wherein the product holder is adjustable relative to the product conveyor in the product supply direction between a starting position spaced apart from the cutting plane and an end position disposed closer to the cutting plane.

32. An apparatus in accordance with claim 16, wherein the product holder includes a controllable gripping apparatus.

33. An apparatus in accordance with claim 32, wherein the controllable gripping apparatus includes at least two mutually pivotable holding claws.

34. A method of slicing food products in which at least one product to be sliced is supplied along a product supply direction to a cutting plane in which a cutting blade moves,
wherein the method includes the following steps:
positioning a product holder able to be brought into engagement with the product in a waiting position releasing the path for the product;
supplying the product by means of a continuous product conveyor;
moving the product holder into a working position behind the product and/or in the path for the product when the rear product end or a rear end region of the product has moved past the product holder located in the waiting position or is located in the region of the product holder;
bringing the product holder into engagement with the product and moving the product holder and the product along the product supply direction; and
returning the product holder into the waiting position when the cutting process is terminated.

35. A method in accordance with claim 34, wherein the cutting blade moves in a rotating and/or revolving manner, and/or wherein the product holder is brought into engagement with the rear end region of the product or with the rear product end.

36. A method in accordance with claim 34, wherein the product holder supports the product conveyor on the supply of the product or takes over the supply of the product from the product conveyor when the product holder is in engagement with the product.

37. A method in accordance with claim 34, wherein the product holder and the product conveyor form a unit or belong to a common assembly, and with the product holder being moved relative to the product conveyor for supplying the product or with the product conveyor being moved as a whole with the product holder and/or wherein the product holder is integrated into the product conveyor.
